(19) United States
(12) Patent Application Publication
(10) Pub. No.: US 2010/0201915 A1
(43) Pub. Date: Aug. 12, 2010

(54) DISCHARGE TUBE FOR INFRARED COMMUNICATION INTERFERENCE SUPPRESSION, LIGHTING DEVICE FOR DISPLAY DEVICES, AND LIQUID CRYSTAL DISPLAY DEVICE

(76) Inventor: Masashi Yokota, Osaka (JP)

Correspondence Address: BIRCH STEWART KOLASCH & BIRCH, PO BOX 747, FALLS CHURCH, VA, 22040-0747, US

(21) Appl. No.: 12/676,189

(22) PCT Filed: Jun. 13, 2008
(86) PCT No.: PCT/JP2008/060888

§ 371 Date: Mar. 3, 2010

(30) Foreign Application Priority Data
Sep. 25, 2007 (JP) 2007-247982

(51) Int. Cl. G02F 1/13357; H01J 61/20; H01J 61/42; G09F 13/08; G02F 1/1335

(52) U.S. Cl. 349/62; 313/642; 313/485; 362/97.1; 349/70

(57) ABSTRACT

The present invention provides a discharge tube for infrared communication interference suppression, a lighting device for liquid crystal display devices, and a liquid crystal display device, each capable of suppressing infrared communication interference. The present invention is a discharge tube for infrared communication interference suppression, including a pair of electrodes, wherein the discharge tube contains mercury, argon gas, and rare gas thereinside, the rare gas having an excitation energy lower than that of argon gas. Krypton gas is mentioned as the rare gas. The discharge tube may further contain neon gas thereinside.

### TECHNICAL FIELD

The present invention relates to a discharge tube for infrared communication interference suppression, a lighting device for display devices, and a liquid crystal display device. More particularly, the present invention relates to a discharge tube for infrared communication interference suppression, preferably used as a light source of a backlight of LCD devices. The present invention also relates to a lighting device for display devices, and a liquid crystal display device.

### BACKGROUND ART

LCD devices are now used in many scenes, both indoors such as home, office, and car, and outdoors, because of their advantages such as slim profile, light weight, low power consumption, and excellent color display. Among these LCD devices, reflective LCD devices can maximize advantages such as slim profile, light weight, and low power consumption, and various reflective LCD display devices have been disclosed. Among these LCD devices, transmissive LCD devices provide excellent color display best, and such transmissive LCD devices essentially include a lighting device such as a backlight.

Various light sources such as a bulb, an EL (electroluminescent) light source, fluorescent tubes such as a CCFT (cold cathode fluorescent tube) and a HCFT (hot cathode fluorescent tube), a LED (light emitting diode), and a metal halide lamp are now used as a light source of a backlight of such transmissive LCD devices. Now CCFTs are mainly used because of a decrease in tube diameter (in thickness of a backlight), long lifetime, simple lighting circuit, and light amount.

CCFTs typically include an envelope and a pair of electrodes at both ends of the envelope. The envelope is filled with argon gas and mercury in a proper amount and its inner wall surface is coated with a fluorescent substance. Further, the cathode electrode is a plate, bar, or roll metal or a sintered metal. The principle of light emission of the CCFT is explained as follows. First, an electric field is generated by applying a high voltage between the pair of electrodes disposed at the both ends of the envelope. After generation of the electric field, initial electrons inside the envelope (originally existing electrodes in the envelope, also referred to as primary electrons) are accelerated toward the anode electrode while impacting on and ionizing the discharge gas (α function). This initiates transitional electrical discharge. The positive ions increased by this impact then impact on the cathode electrode, and thereby secondary electrons are released from the cathode electrode (γ function). This initiates electrical discharge (electrical glow discharge). After that, the secondary electrons are produced by γ function, and the positive ions and further the secondary electrons are increased by α function. As a result, the electrical discharge continues.

The argon gas excited by the electron impact ionizes mercury by impacting thereon. The positive ions increased by this also contribute to the electrical discharge. As shown in FIG. 10, the ionization potential of argon gas is 15.8 eV, and the excitation potential (metastable level) thereof is 11.6 eV. The ionization potential of mercury is 10.4 eV. Accordingly, mercury can be ionized at 11.6 eV, and therefore the discharge inception voltage (lighting start voltage, starting voltage) is lower than 15.8 eV of the ionization potential of argon gas. This is called Penning effect (Penning ionization). Specifically, argon gas increases an excitation efficiency of mercury and also decreases the discharge inception voltage. Mercury excited by the impact with the electron and argon gas emits UV when falling back to its ground state. This UV excites the fluorescent substance on the inner wall surface of the envelope to be converted into visible light.

Thus, the envelope is typically filled with argon gas as discharge medium. Besides a shape (area) of the electrodes, a material for the fluorescent substance, and the like, the kind of the discharge medium also determines various characteristics such as luminance and lifetime of the CCFT. So the discharge medium is not limited to argon gas, and rare gases such as neon gas, krypton gas, and xenon gas are used singly or in mixtures thereof (for example, see Non-patent Document 1). If a gas pressure of the discharge medium (gas filling pressure) is high, sputtering of the electrode is suppressed, which leads to long lifetime of the CCFT and an increase in potential gradient in the positive column. However, in such a case, the discharge inception voltage becomes high. So as measures against this, a gaseous mixture of neon and argon is commonly used as the discharge medium for CCFTs used in LCD devices now.

Further, for example, Patent Document 1 discloses a discharge lamp device capable of improving luminance and light emission efficiency, wherein the device drives a light-emitting tube filled with xenon gas or krypton gas, a first electrode is provided inside the tube, and a second electrode is provided outside the tube. Further, for example, Patent Document 2 discloses a light source device having stable light-emitting characteristics and capable of eliminating defects caused by a space inevitably exiting between an external electrode and an outer periphery of a bulb and also capable of certainly preventing dielectric breakdown of ambient gas. Such a light source device includes: at least one bulb; a discharge medium filled inside the bulb, mainly containing rare gas (at least one selected from xenon gas, krypton gas, argon gas, and helium gas); a first electrode arranged inside the bulb; and a second electrode arranged outside the bulb. Further, Non-patent Document 2 also discloses use of argon-krypton gaseous mixture or argon-xenon gaseous mixture as the discharge medium as measures against low luminance.

### [Patent Document 1]

Japanese Kokai Publication No. 2004-55521

### [Patent Document 2]

Japanese Kokai Publication No. 2006-313734

### [Non-patent Document 1]

Suzuki Yasoji, and 5 others, “Yokuwakaru Ekisho dhisupurei no dekirumade”, First edition, published by NIKKAN KOGYO SHINBUN, LTD., Nov. 28, 2005, p. 200 to 202

### [Non-patent Document 2]

Kazunaga Kenji, “bakkuraito yo kogen no kaihatsu doko”, Light Edge, Ushio' s Technology Magazine, USHIO INC, 1995, No 2, p. 16 to 17

### [Non-patent Document 3]

Miyako Tsuyoomi, “diimonium kei kagobutu wo motiita kinsekigaisen kyushyu fyirumu no taikyusei kojyo”, Reports of the Research Laboratory, Asahi Glass Co., Ltd., 2005, vol. 55, p. 67 to 71

### DISCLOSURE OF INVENTION

The present inventor made various investigations on CCFTs including an envelope filled with mercury and discharge medium containing argon gas. Then, the inventor noted the followings. In the early stage of lighting when the inside temperature of the envelope is low, a mercury vapor pressure inside the envelope, largely depending on the inside temperature, does not rise enough. As a result, light emission by argon gas is increased, so infrared at 912 nm is emitted in addition to visible light. Infrared remote controls and infrared receivers (infrared-receiving element) used in IrSS (infrared simple shot, registered trademark)-compliant high-speed infrared communication typically show sensitivity characteristics shown in FIG. 11. So when receiving infrared at 912 nm emitted from a CCFT and the like, infrared communication equipment such as a DVD recorder misidentifies the infrared as a signal from the infrared remote control, possibly resulting in malfunction, or communication failure of IrSS-compliant high-speed infrared communication might occur. Particularly in a LC TV including CCFTs as a light source of a backlight, the inside temperature of an envelope of the CCFT is increased in several tens of seconds to several minutes after lighting of the CCFTs, and then the amount of noise is significantly decreased. However, the absolute quantity of noise is increased with an increase in screen size.

The following ways may be employed for suppressing infrared communication interference.

(1) Argon gas, which emits infrared at 912 nm, is not used, and only krypton gas is used as the discharge medium for the CCFT.
(2) The period of time when the inside temperature of the envelope is low and so infrared at 912 nm is emitted is shortened by increasing the gas filling pressure, thereby allowing easy increase in the inside temperature.
(3) Utilizing the technology shown in Non-patent Document 3, an infrared-absorbing film is arranged to absorb infrared at 912 nm emitted by light emission by argon gas from the CCFTs. However, in the case (1), as shown in FIG. 10, the ionization potential of krypton gas is 14.0 eV, and the excitation potential (metastable level) thereof is 9.9 eV. So the discharge inception voltage becomes high. In the case (2), the impedance of the discharge tube becomes high, which leads to a reduction in light-emitting efficiency (luminance). In the case (3), infrared with a high intensity, emitted by argon gas, has a wide peak, and so the film absorbs also visible light, which leads to a decrease in luminance.

Patent Documents 1 and 2, Non-patent Documents 1 and 2 fails to refer to such technical subjects and measures against them.

The present invention has been made in view of the above-mentioned state of the art. The present invention has an object to provide a discharge tube for infrared communication interference suppression, a lighting device for display devices, and a liquid crystal display device, each capable of suppressing infrared communication interference.

The present inventor made various investigations on CCFTs for infrared communication interference suppression and noted a composition of the discharge medium. Further, the inventor found that infrared communication interference can be suppressed in the following embodiment. If the discharge medium contains argon gas and krypton gas with an excitation energy lower than that of argon gas, light emission by argon gas in the early stage of lighting when the inside temperature of the tube is low can be decreased. This leads to a decrease in emission intensity of infrared at 912 nm. As a result, infrared communication interference can be suppressed. In the early stage when the inside temperature of the tube is low, krypton gas dominantly emits light. However, the wavelength band where the intensity of infrared emitted by krypton gas is high is narrower than the wavelength band where the intensity of infrared emitted by argon gas is high. So a combination use of this CCFT and an infrared-absorbing sheet substantially not absorbing visible light permits an effective reduction in intensity of infrared to be emitted, without a decrease in luminance of the CCFT. The operation and effects of the present invention are not limited to the CCFT theoretically, and can be also obtained by use of other discharge tubes such as a HCFT (hot cathode fluorescent tube). Further, the discharge medium is not especially limited to krypton gas, and the same effects can be obtained even in use of rare gas with an excitation energy lower than that of argon gas. Based on these findings, the above-mentioned problems have been admirably solved, leading to completion of the present invention.

That is, the present invention is a discharge tube for infrared communication interference suppression, including a pair of electrodes,

wherein the discharge tube contains mercury, argon gas, and rare gas thereinside,

the rare gas having an excitation energy lower than that of argon gas.

The present invention is mentioned below in detail.

The discharge tube for infrared communication interference suppression of the present invention includes a pair of electrodes. The “discharge tube” used herein means a light source utilizing light emission produced by gas electrical discharge and it is also called “discharge lamp”. The shape of the tube is not especially limited. A tubular, flat one, and the like, may be used. The pair of electrodes is typically arranged inside the tube at both ends thereof to start discharge in gas inside the tube by a voltage applied between the electrodes.

The application of the discharge tube of the present invention is not especially limited as long as it is used for the purpose of suppressing infrared communication interference. Examples of the application include a light source of a lighting device for display devices, such as a backlight and a front light; and other living lamps such as a fluorescent lamp. Infrared communication equipment such as infrared remote control is now popularly used in households. In order to prevent malfunction of such infrared communication equipment, it is preferable that the discharge tube of the present invention is used as a light source of a TV receiver, and the like. That is, it is preferable that the discharge tube of the present invention is a discharge tube for TV receivers.

The above-mentioned discharge tube is filled with mercury, argon gas, and rare gas with an excitation energy lower than that of argon gas (hereinafter, also referred to as rare gas for argon light emission suppression). Liquid mercury (mercury particles) and mercury vapor are contained inside the tube. Argon gas and the rare gas for argon light emission suppression are the discharge medium (buffer gas). The “excitation energy” used herein means an energy amount needed to excite atoms from the ground state under no voltage application into excited states from which they can emit light.

Argon is excited by impacting with a primary electron or a secondary electron, and ionizes mercury by impacting therewith, thereby producing electrical discharge. The ionization energy of argon gas is higher than the excitation energy of mercury. So if the discharge medium contains argon gas, the excitation efficiency of mercury can be enhanced by Penning effect, and further the discharge inception voltage can be decreased. Further, argon gas contained in the discharge medium also provides advantages such as suppression of sputtering of an electrode (a cold cathode and the like).

If the discharge medium further contains the rare gas for argon light emission suppression with an excitation energy lower than that of argon gas, the excitation energy of argon gas excited by the impact with the electron is immediately transferred to the rare gas for argon light emission suppression. As a result, in the early stage of lighting when the inside temperature of the tube is low, light emission by the rare gas becomes dominant along with a decrease in light emission by argon gas. Thus, the emission intensity of infrared at 912 nm which is mainly attributed to the infrared communication interference can be lowered. The ionization energy of the rare gas is higher than the excitation energy of mercury, and so the excitation efficiency of mercury can be improved.

Examples of the rare gas for argon light emission suppression include krypton gas (ionization potential (ionization energy): 14.0 eV, excitation potential (excitation energy): 9.9 eV); and xenon gas (ionization potential: 12.1 eV, excitation potential: 8.3 eV) (see FIG. 10). As shown in light emission spectrums of argon gas and xenon gas, the peak of the infrared with a high intensity is within a wide wavelength band of 800 to 1000 nm. In contrast, with respect to light emission spectrum of krypton gas, the peak of the infrared with a high intensity is within a narrow wavelength band of 800 to 900 nm. So if the discharge medium does not contain krypton gas, the intensity of infrared needs to be decreased over a wide wavelength band, but pigments with such a property have usually a large absorbing amount of visible light. If the discharge medium contains krypton gas, the intensity of infrared needs to be decreased in a narrow wavelength band, but pigments with such a property have a relatively small absorbing amount of visible light. So the above-mentioned rare gas is preferably krypton gas in order to improve use efficiency of visible light while infrared communication interference is suppressed.

It is preferable that a volume concentration of the rare gas for argon light emission suppression is 1 to 10 vol %. The rare gas is easily incorporated into sputtered electrode substance. So the rare gas is easily exhausted if the volume concentration thereof is lower than 1 vol %, possibly resulting in a short period of time when the operation and effects of the present invention are obtained. If the volume concentration thereof is higher than 10 vol %, the impedance of the discharge tube becomes high and the power consumption is increased, which leads to a decrease in luminance. For example, an increase in volume concentration of krypton gas by 5 vol % decreases about 14% of the luminance. In view of the operation and effects of the present invention, the volume concentration of the rare gas is preferably 1 to 5 vol % and more preferably 1 to 3 vol %. The above-mentioned volume concentration is a volume of gas with the number of moles equivalent to that of the rare gas inside the discharge tube relative to a volume of gas with the number of moles equivalent to the total number of moles of gases inside the discharge tube at 25° C. and 1 atmosphere. So the above-mentioned volume concentration corresponds to a partial pressure of the rare gas inside the discharge tube.

According to the discharge tube of the present invention, the discharge medium may contain gases such as rare gas with an excitation energy higher than that of argon gas, other than argon gas and the rare gas for argon light emission suppression as long as the operation and effects of the present invention are obtained. For example, it is preferable that the discharge tube further contains neon gas (ionization potential: 21.6 eV, excitation potential: 16.6 eV) thereinside. Attributed to neon gas contained as the discharge medium, the discharge inception voltage can be decreased without increasing the gas filling pressure so much. It is preferable that the volume concentration of the neon gas is 99 vol % or lower. If the volume concentration of the neon gas is higher than 99 vol %, the volume concentration of argon gas is lower than 1 vol %, which results in that argon gas is easily exhausted. If argon gas is exhausted, light (pink light) produced only by neon gas discharge is strongly emitted, which possibly results in that such a light source can not be used as a light source for display devices. In view of Penning effect, the above-mentioned discharge medium preferably contains argon gas, the rare gas for argon light emission suppression, and neon gas, and more preferably contains argon gas, krypton gas, and neon gas.

It is preferable that the discharge tube contains, on a wall face thereof, a fluorescent substance capable of converting ultraviolet emitted from the mercury excited by an electric discharge into visible light. Specifically, the discharge tube of the present invention is a fluorescent tube (fluorescent lamp). Such a fluorescent tube can emit visible light, so is preferably used as a light source in a lighting device for display devices. The fluorescent substance may be formed on the outer wall surface or the inner wall surface of the tube, and preferably formed on the inner wall surface thereof.

The fluorescent substance may be contained in a material for the wall and may exist inside the wall.

Examples of the above-mentioned fluorescent tube include CCFTs and HCFTs. In view of a decrease in tube diameter, a long lifetime of the tube, a simple lighting circuit, and a light amount, CCFTs are preferable. Further, in view of a high luminance, HCFTs are preferable. The fluorescent tube usually includes a lighting circuit. The lighting circuit has the following basic functions (1) and (2), for example: (1) A specific voltage is applied to the pair of electrodes arranged inside the tube, thereby starting electric discharge; (2) After the start of the discharge, a current flowing in the discharge tube can be kept at a proper value.

It is preferable that the discharge tube is a cold cathode fluorescent tube, and

a gas pressure inside the tube is 6.7×10³ Pa or lower. In common discharge tubes, the reduction in the gas filling pressure allows a decrease in power consumption, but makes it difficult to increase the inside temperature of the discharge tube. So the period of time when infrared at 912 nm is emitted by argon gas becomes longer, which increases the period of time where infrared communication is interfered. However, according to the discharge tube of the present invention, the discharge medium contains argon gas and the rare gas for argon light emission suppression. So the emission of infrared at 912 nm can be suppressed even if the gas filling pressure is 6.7×10³ Pa or lower. Specifically, by setting the gas filling pressure to 6.7×10³ Pa or lower in the discharge tube of the present invention, the infrared communication interference can be suppressed, and simultaneously the power consumption can be decreased. Further, the decrease in impedance of the discharge tube permits a high luminance. So such a discharge tube-including LCD device does not need optical sheets such as a retroreflection sheet and a prism sheet, which results in reduction in costs. The gas filling pressure can be determined, for example, by measuring a gas volume by breaking the discharge tube in a liquid.

The discharge tube of the present invention is not especially limited, and it may include other components as long as it includes the pair of electrodes, mercury, argon gas, the rare gas for argon light emission suppression.

The present invention is also a lighting device for display devices, including the discharge tube. According to the discharge tube of the present invention, the infrared communication interference can be suppressed, so a lighting device for display devices including such a discharge tube does not interfere with infrared communication. The application of the lighting device for display devices of the present invention is not especially limited as long as the lighting device is used for display devices. Among these, it is preferably used for LCD devices. The lighting device for display devices may be a direct type (fluorescent tubes are arranged just below a display face) or a side-light type (fluorescent tubes are arranged on a side of a display face). In view of high light use efficiency and high luminance, the direct type is preferable. In view of slim profile and luminance uniformity, the side-light type is preferable.

The lighting device of the present invention is not especially limited and it may include other components as long as it includes the above-mentioned discharge tube. Examples of the other components include optical members such as a reflector, a diffuser, and a light guider.

It is preferable that the lighting device including an infrared-absorbing sheet capable of absorbing infrared emitted from the discharge tube by emission of light produced by the rare gas. According to this, it is possible to suppress this lighting device from interfering with equipment including infrared communication means. Examples of the material for the infrared-absorbing sheet include infrared-absorbing dyes such as monium salts, cyanine dyes, phthalocyanine dyes, and azo dyes. The infrared-absorbing sheet is not especially limited as long as it absorbs at least a part of infrared emitted by the rare gas for argon light emission suppression and from the discharge tube. It is preferable that the sheet absorbs infrared at 780 to 1200 nm. It is preferable that the sheet shows a transmittance of 50% or less for infrared at 800 to 900 nm.

It is preferable that the infrared-absorbing sheet does not substantially absorb visible light. Hereinafter, the sheet which can absorb infrared emitted by the rare gas for argon light emission suppression and from the discharge tube and which does not substantially absorb visible light is referred to as “narrowband infrared-absorbing sheet”. As shown in light emission spectrum of argon gas, the infrared with a high intensity has a peak within a wide wavelength band of 800 nm or longer and just over 1000 nm. In order to suppress infrared communication interference, an infrared-absorbing sheet that absorbs infrared in at least this wavelength band needs to be used. However, such an infrared-absorbing sheet typically has a second absorption peak within a visible wavelength band of 380 to 780 nm. So as in the present invention, the discharge medium contains krypton gas in addition to argon gas, the peak of infrared with a high intensity can be within a wavelength band of 800 to 900 nm. This permits that the narrowband infrared-absorbing sheet, not having the second absorption peak in the visible wavelength band, selectively absorbs infrared. Specifically, the infrared communication interference can be effectively suppressed while the reduction in luminance is suppressed.

Examples of the material for the narrowband infrared-absorbing sheet include organic dyes such as cyanine dyes, phthalocyanine dyes, and azo dyes, As mentioned above, “if the sheet does not substantially absorb visible light” means that the sheet has a transmittance of 60% or more for light in a visible wavelength band.

The infrared-absorbing sheet may be arranged at any position as long as it can absorb infrared emitted from the discharge tube. It is preferable that the infrared-absorbing sheet is arranged on an outermost light-exiting face side of the lighting device. If the infrared-absorbing sheet is arranged close to the discharge tube, the reduction in luminance might be large. If the lighting device for display devices of the present invention includes a retroreflection sheet and retroreflects light emitted from the discharge tube inside the lighting device, it is preferable that the infrared-absorbing sheet is arranged on the light-exiting face side of the retroreflection sheet. As a result, light passes through the infrared-absorbing sheet two or more times, and thereby the large reduction in luminance of the visible light used for display can be suppressed.

The present invention is a LCD device including: the above-mentioned lighting device; and a LCD panel. Such a LCD device of the present invention does not cause infrared communication interference. Further, high value-added LCD devices including an IrSS-compliant light receiver also can be provided.

The LCD device of the present invention is not especially limited and may include other components as long as it includes the above-mentioned lighting device for display devices and a LCD panel. The lighting device for display devices may be arranged on a back face side of the LCD panel (may be a backlight of the LCD device), or may be arranged on a front face side of the LCD panel (may be a front light of the LCD device).

According to one preferable embodiment of the lighting device for display devices of the present invention, the LCD panel includes a back polarizer, a liquid crystal layer, and a front polarizer in this order from the lighting device side, and

the LCD device includes the infrared-absorbing sheet between the lighting device and the back polarizer,

the infrared-absorbing sheet being capable of absorbing infrared emitted from the discharge tube by emission of light produced by the rare gas. If the infrared-absorbing sheet is arranged between polarization elements, depolarization by the sheet occurs, which might reduce the contrast ratio. So by arranging infrared-absorbing sheet between the lighting device for display devices and the back polarizer, a high contrast ratio can be provided. The polarizer is not especially limited as long as it is an optical member having a function of transmitting only a specific polarization component of incident light. Polarizers providing linear polarization, circular polarization, and elliptical polarization, and the like, may be used as the polarizer. In order to absorb infrared completely, it is preferable that the infrared-absorbing sheet is arranged over the entire display screen.

According to another preferable embodiment of the lighting device for display devices of the present invention, the LCD panel includes a back polarizer, a liquid crystal layer, and a front polarizer in this order from the lighting device, and

the LCD device includes the infrared-absorbing sheet on a front face-side of the front polarizer,

the infrared-absorbing sheet being capable of absorbing infrared emitted from the discharge tube by emission of light produced by the rare gas. If the infrared-absorbing sheet is arranged close to the discharge tube, the reduction in luminance might be large. Specifically, the infrared-absorbing sheet is arranged on the front face-side of the front polarizer, and thereby a high luminance can be obtained. In order to absorb the infrared completely, the infrared-absorbing sheet is preferably arranged in the entire display screen.

According to another preferable embodiment of the liquid crystal display device of the present invention, the LCD panel includes a polarizer-protecting layer containing an infrared-absorbing dye. Such a polarizer-protecting layer containing an infrared-absorbing dye obviates the need for the infrared-absorbing sheet. This allows a slim profile of the LCD device, a simple structure thereof, and a reduction in production costs. In order to enhance display qualities such as light use efficiency, contrast ratio, and the like, an embodiment in which the polarizer-protecting layer is arranged on the lighting device-side surface of the LCD panel is preferable.

### EFFECT OF THE INVENTION

The discharge tube of the present invention contains rare gas with an excitation energy lower than that of argon gas, so light emission by argon gas in the early stage of lighting can be suppressed. As a result, the emission intensity of infrared at 912 nm can be decreased, thereby suppressing infrared communication interference.

### BEST MODES FOR CARRYING OUT THE INVENTION

The present invention is mentioned in more detail below with reference to Embodiments, but not limited to only these Embodiments.

### Embodiment 1

FIG. 1 is a cross-sectional view schematically showing a configuration of a LCD device of Embodiment 1.

The LCD device of Embodiment 1 includes a lighting device for display devices 100 and a LCD panel 200.

The lighting device for display devices 100 is a direct type backlight for LCD devices. The lighting device 100 includes a backlight (BL) shield 10, a reflection sheet 11, a CCFT 12, a diffuser 13, a diffusion sheet 14, a prism sheet 15, a luminance-enhancing film (trade name: DBEF (dual brightness enhance film), product of Sumitomo 3M Ltd.) 16, and an infrared-absorbing sheet 50, stacked in this order from the back side.

FIG. 2 is a cross-sectional view schematically showing a configuration of the CCFT 12. Although not shown in FIG. 2, a lighting circuit and the like is connected to the CCFT 12.

The CCFT 12 of the present Embodiment includes a glass envelope 120 filled with mercury particles and a discharge medium containing argon gas, neon gas, and krypton gas. The volume concentrations of neon gas, argon gas, krypton gas are 0 to 98 vol %, 1 to 99 vol %, and 1 to 99 vol %, respectively. The gas filling pressure is set to 8.0×10³ Pa in the present Embodiment.

The material for the cold cathode electrode 121a is not especially limited, and examples thereof include nickel (Ni), molybdenum (Mo), niobium (Nb), and tungsten (W). Ni, Mo, Nb, and W are ranked in descending order of sputtering ratio. Ni is preferable in view of cost reduction. W is preferable in view of long lifetime. In view of both of long lifetime and cost reduction, molybdenum (Mo) and niobium (Nb) are preferred. So according to the present Embodiment, Mo and Nb are used. The shape of the cold cathode electrode 121a is not especially limited, and it may be a plate, bar, tube, cup shape, and the like. The present Embodiment adopts a cup shape in view of both long lifetime and cost reduction.

The material for an anode electrode 121b is not especially limited, and it may be Ni, Mo, Nb, W, and the like, for example. From a viewpoint of cost reduction, Ni is preferable. In view of long lifetime, Mo, Nb, and W are preferred. The present Embodiment adopts Mo in view of long lifetime. The shape of the anode electrode 121b is not especially limited, and it may be a bar, plate, sleeve, cup shape. The present Embodiment adopts a cup shape in view of long lifetime.

The inner wall of the glass envelop 120 is coated with a fluorescent substance 122 converting UV at 253.7 nm into visible light, the UV being produced from mercury excited by electrical discharge. YOX/YVO/GeMn and the like may be used as a red fluorescent substance. BamMn/Lap and the like may be used as a green fluorescent substance. SCA/Bam and the like may be used as a blue fluorescent substance.

The infrared-absorbing sheet 50 arranged on the outermost light-exiting face side of the lighting device 100 absorbs infrared emitted by light emission by krypton gas filled in the CCFT 12. According to the present Embodiment, the sheet 50 is formed by coating and attached to the film 16 with a cohesive agent therebetween.

The LCD panel 200 has a structure in which a liquid crystal layer 23 and a color filter 24 are arranged between a back substrate 20a and a front substrate 20b. A polarizer 21a is attached to the back substrate 20a with a cohesive layer 22a therebetween, and a front polarizer 21b is attached to the front substrate 20b with a cohesive layer 22b therebetween. The back polarizer 21a has a structure in which a first protective layer 1a, a first polarizer 2a, and a second protective layer 1b are stacked in this order from the back face side. The front polarizer 21b has a structure in which a third protective layer 1c, a second polarizer 2b, and a forth protective layer 1d are stacked in this order from the back face side.

According to the present Embodiment, the CCFT 12 contains krypton gas with an excitation energy lower than that of argon gas as the discharge medium. So light emission by argon gas in the early stage of lighting when the inside temperature of the envelope is low can be lowered, and as a result, the emission intensity of infrared at 912 nm mainly attributed to the infrared communication interference can be decreased. Although instead of argon gas krypton gas produces light emission and so infrared at 878 nm and 893 nm possibly causing infrared communication interference is emitted from the CCFT 12, such infrared can be effectively cut by the infrared-absorbing sheet 50. The sheet 50 has a relatively low absorption amount of visible light, and further, it is arranged on the outermost light-exiting face side of the lighting device according to the present Embodiment, so visible light is not absorbed by the sheet 50 repeatedly. As a result, a high luminance (87% relative to the light-emission intensity of CCFT) can be obtained.

If the volume concentration of krypton gas is within a range of 1 to 3 vol %, it is possible to prevent a reduction in period of time when the operation and effects of the present invention are obtained, the reduction being caused when krypton gas is absorbed by sputtered materials for the cold cathode electrode 121 to be exhausted. Further, in such a case, the impedance of the discharge tube does not become so high, which can suppress an increase in power consumption and a reduction in light-emission luminance. Further, the discharge medium contains neon gas, and so the discharge inception voltage can be decreased without increasing the gas filling pressure so much. In addition, the gas filling pressure is 6.7×10³ Pa or lower, which leads to low power consumption. According to the present Embodiment, attributed to the use of krypton gas in addition to argon gas as the discharge medium, the interference of infrared communication does not occur by setting the gas filling pressure to 6.7×10³ Pa or lower even if the time until the inside temperature of the tube reaches a sufficient high temperature after lighting is long.

Materials and forming methods for various members constituting the LCD device according to Embodiment 1 are mentioned below.

The back substrate 20a and the front substrate 20b are not especially limited and they may be a glass (alkali free glass and the like) substrate, a plastic substrate. The present Embodiment adopts a glass substrate. The color filter 24 is not especially limited as long as it is a filter that selectively transmits light in a specific wavelength band. The material for the color filter 24 is not especially limited, and may be a dyed resin, a resin containing a pigment dispersed thereinto, and a solidified substance of a fluid material containing a pigment dispersed thereinto (ink). The method of forming the color filter 24 is not especially limited, and for example, dyeing, pigment dispersion, electrodeposition, printing, ink-jet, a color resist method (also called “transfer printing”, “DFL (dry film lamination)”, or “dry film resist”), and the like may be employed. The first to fourth protective layers 1a to 1d are not especially limited. The present Embodiment adopts a TAC (triacetyl cellulose) film. The first and second polarizers 2a and 2b are not especially limited, but they are prepared by adsorbing iodine to a polyvinyl alcohol (PVA) film and then uniaxially stretching the film.

A silver thin film may be used as the reflective sheet 11. The diffusion sheet 14 is used for light diffusion, and a PET film, and the like, may be used as the diffusion sheet 14. The prism sheet 15 is used for improving the luminance of the LCD panel. The material for the prism sheet is not especially limited, and thermoplastic resins, UV curable resins, and the like, may be used.

### Embodiment 2

A LCD device of Embodiment 2 is the same as in Embodiment 1, except that the infrared-absorbing sheet 50 is arranged between the prism sheet 15 and the luminance-enhancing film 16. According to the present Embodiment, the absorption amount of visible light by the sheet 50 is larger than that in Embodiment 1. So the luminance is somewhat reduced (80% relative to the light-emission intensity of the CCFT), but the same operation and effects as in Embodiment 1 can be provided.

### Embodiment 3

A LCD device of Embodiment 3 is the same as in Embodiment 1, except that the sheet 50 is arranged between the diffusion sheet 14 and the prism sheet 15. According to the present Embodiment, the absorption amount of visible light by the sheet 50 is larger than that in Embodiment 1. So the luminance is somewhat reduced (71% relative to the light-emission intensity of the CCFT), but the same operation and effects as in Embodiment 1 can be provided.

### Embodiment 4

A LCD device of Embodiment 4 is the same as in Embodiment 1, except that the sheet 50 is arranged between the diffuser 13 and the diffusion sheet 14. According to the present Embodiment, the absorption amount of visible light by the sheet 50 is larger than that in Embodiment 1. So the luminance is somewhat reduced (65% relative to light-emission intensity of the CCFT), but the same operation and effects as in Embodiment 1 can be provided.

### Embodiment 5

FIG. 3 is a cross-sectional view schematically showing a configuration of a LCD device of Embodiment 5.

The LCD device of Embodiment 5 is the same as in Embodiment 1, except that as shown in FIG. 3, the sheet 50 is not arranged, and the first protective layer 1a of the back polarizer 21a is replaced with a protective layer 50a containing an infrared-absorbing dye. According to the present Embodiment, the device does not need to include the infrared-absorbing sheet. This leads to a decrease in production costs.

### Noise Evaluation of Backlight

FIG. 4 is a schematic view showing a way of a noise evaluation test of a backlight.

A LC TV receiver 500c including, as a light source of a backlight, CCFTs (gas pressure: 8.0×10³ Pa) containing Ar gas (5 vol %), Kr gas (2 vol %), and Ne gas (93 vol %) filled in an envelope was prepared. As shown in FIG. 4, a silicon photo diode (PD) 60 was secured with a distance of 10 cm from the receiver 500c. The PD 60 was measured for change with time in photocurrent (I_{pd}) at −10° C. with a tester.

Next, the light source of the backlight was replaced with a CCFT (gas pressure: 8.0×10³ Pa) not containing Kr gas but containing only Ar gas (5 vol %) and Ne gas (95 vol %) filled in an envelope. Then, the PD 60 was measured for change with time in photocurrent (I_{pd}) under the same condition with a tester. The following Table 1 and FIG. 5 show measurement results. In order to decrease electromagnetic noise, a shielding net 70 was arranged between the LC TV receiver 500c and the silicon photo diode 60 as shown in FIG. 4. The shield effect attributed to the shield net 70 made it easy to measure a waveform of light, but the photocurrent was lowered because the light-receiving amount of the PD 60 was decreased. The LC TV receiver 500c subjected to the measurement has the same configuration as the LCD device of Embodiment 1, except that it includes no sheet 50. A silicon PD showing such sensitivity characteristics of a light-receiving portion of an infrared remote control as shown in FIG. 11 is used as the PD 60.

TABLE 1

PD photocurrent (μA)

| Time (min) | (i) with Kr gas | (ii) without Kr gas |
|---|---|---|
| 0.5 | 0.73 | 1.85 |
| 1 | 0.228 | 0.54 |
| 2 | 0.148 | 0.225 |
| 3 | 0.11 | 0.155 |
| 5 | 0.094 | 0.11 |
| 7 | 0.086 | 0.1 |
| 10 | 0.076 | 0.076 |

As shown in Table 1 and FIG. 5, if the CCFT contains no Kr gas, the photocurrent of the PD just after power is turned on is high. This would be because the inside temperature of the envelope of the CCFT is low just after power is turned on and the mercury vapor pressure is not sufficiently increased, and thereby infrared at 912 nm is strongly emitted by Ar gas. In contrast, if the envelope is filed with also Kr gas, the photocurrent of the PD is sufficiently low just after power is turned on. This would be because the excitation energy of Ar gas is immediately transferred into Kr gas with an excitation energy lower than Ar gas, and the emission intensity of infrared at 912 nm by light emission by Ar gas is reduced.

Relationship Between Kr Gas Volume Concentration and Infrared Remote Control Distance after Backlight is Turned on

FIG. 6 is a schematic view showing measurement layout of the infrared remote control distance.

As shown in the following Table 2, four kinds of LC TV receivers (i) to (iv) including a CCFT (gas pressure: 8.0×10³ Pa) as a light source of a backlight were prepared as a noise source. Then, as shown in FIG. 6, a LC TV receiver 500d, which is a noise source, was secured, and a LC TV receiver 500e including an infrared-absorbing film as a light-receiving element was secured with about 10 cm (a distance D in FIG. 6) from the LC TV receiver 500d. Then, while an infrared remote control 80, which was positioned in front of the PD 61 secured at the front face of the LC TV receiver 500e, was moved in the arrow A direction under a room temperature, remote control operation for the LC TV receiver 500e was performed many times. The maximum distance where the receiver 500e could work by every remote control operation is defined as the “remote control distance”. The following Table 2 and FIG. 7 show the measurement results. The LC TV receivers (i) and (ii) have the same configuration as the LCD device of Embodiment 1, except that the receivers (i) and (ii) includes no sheet 50. The LC TV receivers (iii), (iv), and the LC TV receiver 500e, which is light-receiving equipment, have the same configuration as in the LCD device of Embodiment 1. A material that shows spectral characteristics similar to that of the diimonium compound disclosed in Non patent Document 3 is used as the material for the infrared-absorbing sheet 50. A silicon PD showing such sensitivity characteristics of a light-receiving portion of an infrared remote control as shown in FIG. 11 is used as the PD 61.

TABLE 2

| | Ar gas | Kr gas | Ne gas | | Remote |
|---|---|---|---|---|---|
| | volume con- | volume con- | volume con- | IR- | control |
| LC TV | centration | centration | centration | absorbing | distance |
| receiver | (vol %) | (vol %) | (vol %) | sheet | (m) |
| (i) | 5.0 | 0 | 95 | without | 2.5 |
| (ii) | 5.0 | 2.0 | 93 | without | 5.0 |
| (iii) | 5.0 | 0 | 95 | with | 6.0 |
| (iv) | 5.0 | 2.0 | 93 | with | 12.6 |

As shown in Table 2 and FIG. 7, a comparison between the receivers (i) and (ii) shows that the increase in Kr gas volume concentration inside the CCFT from 0 vol % to 2.0 vol % extends the remote control distance after turn-on of the backlight by 2.5 m. This would be because the excitation energy of Ar gas is immediately transferred to Kr gas with an excitation energy lower than that of argon gas, and the emission intensity of infrared at 912 nm emitted by light emission by Ar gas is reduced, thereby increasing a S/N ratio of the silicon photodiode, which is an infrared-receiver. Further, a comparison between (i) and (iii) shows that when Kr gas is not contained inside the envelope of the CCFT, the use of the infrared-absorbing sheet permits an extension of the remote control distance only by 3.5 m. In contrast, a comparison between (ii) and (iv) shows that when Kr gas of 2 vol % is contained in the envelope of the CCFT, the use of the infrared-absorbing sheet permits an extension thereof by 7.6 m. This would be because the infrared with a large intensity emitted by Ar gas has a peak within a wide wavelength band of 800 or longer and just over 1000 nm, but the infrared with a large intensity emitted by Kr gas has a peak within a wavelength band of 800 to 900 nm, and so the infrared emitted from the CCFT can be effectively absorbed by the infrared-absorbing sheet.

### Relationship Between Kr Gas Volume Concentration and Luminance of CCFT

FIG. 8 is a graph showing a relationship between Kr gas volume concentration inside the CCFT and a luminance of the CCFT (the tube current is fixed at 5 mA). The gas filling pressure is 8.0×10³ Pa. The voltage concentration of Kr gas is adjusted by Ne gas volume concentration. An increase in Kr gas volume concentration in the CCFT increases the impedance of the CCFT, and so under the same tube current, the luminance of the CCFT might be decreased. However, as shown in FIG. 8, the reduction in luminance of the CCFT can be suppressed when 5 vol % or less of Kr gas is contained in the CCFT.

### Relationship Between Gas Filling Pressure and Luminance of CCFT

FIG. 9 is a graph showing gas pressure dependency of luminance of CCFT (Ar gas: 5 vol %, Ne gas: 95 vol %). FIG. 9 shows that the luminance can be increased with a decrease in gas filling pressure. This tendency is also observed in a mixture of Ar, Ne, and Kr.

The present application claims priority to Patent Application No. 2007-247982 filed in Japan on Sep. 25, 2007 under the Paris Convention and provisions of national law in a designated State, the entire contents of which are hereby incorporated by reference.

### BRIEF DESCRIPTION OF DRAWINGS

FIG. 1 is a cross-sectional view schematically showing a configuration of the LCD device in accordance with Embodiment 1.

FIG. 2 is a cross-sectional view schematically showing a configuration of the cold cathode fluorescent tube used in the LCD device in accordance with Embodiment 1.

FIG. 3 is a cross-sectional view schematically showing a configuration of the LCD device in accordance with Embodiment 5.

FIG. 4 is a schematic view showing a way of the noise evaluation test of the backlight.

FIG. 5 is a graph showing change with time in photocurrent (I_{pd}) of silicon photo diode.

FIG. 6 is a schematic view showing measurement layout of the remote control distance.

FIG. 7 is a graph showing a relationship between the Kr gas volume concentration inside the CCFT and the remote control distance after the backlight is turned on.

FIG. 8 is a graph showing a relationship between the Kr gas volume concentration inside the CCFT and the luminance.

FIG. 9 is a graph showing the gas pressure dependency of luminance of the CCFT (1 Torr=133.32 Pa).

FIG. 10 is a graph showing excitation potentials (excitation energy) and ionization potentials (ionization energy) of mercury and rare gas.

FIG. 11 is a graph showing sensitivity characteristics of the light-receiving portions of the infrared remote control and the IrSS-equipment.

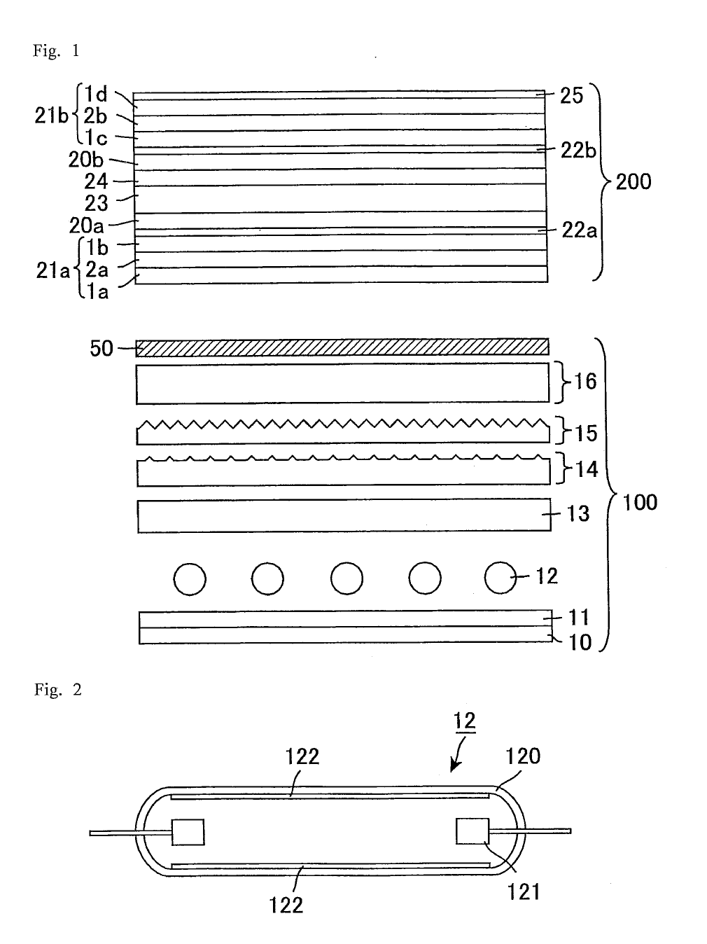

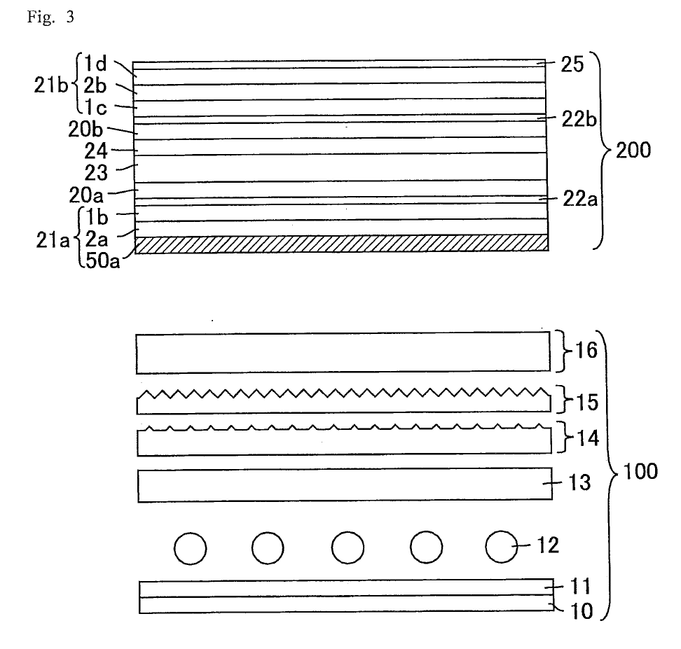

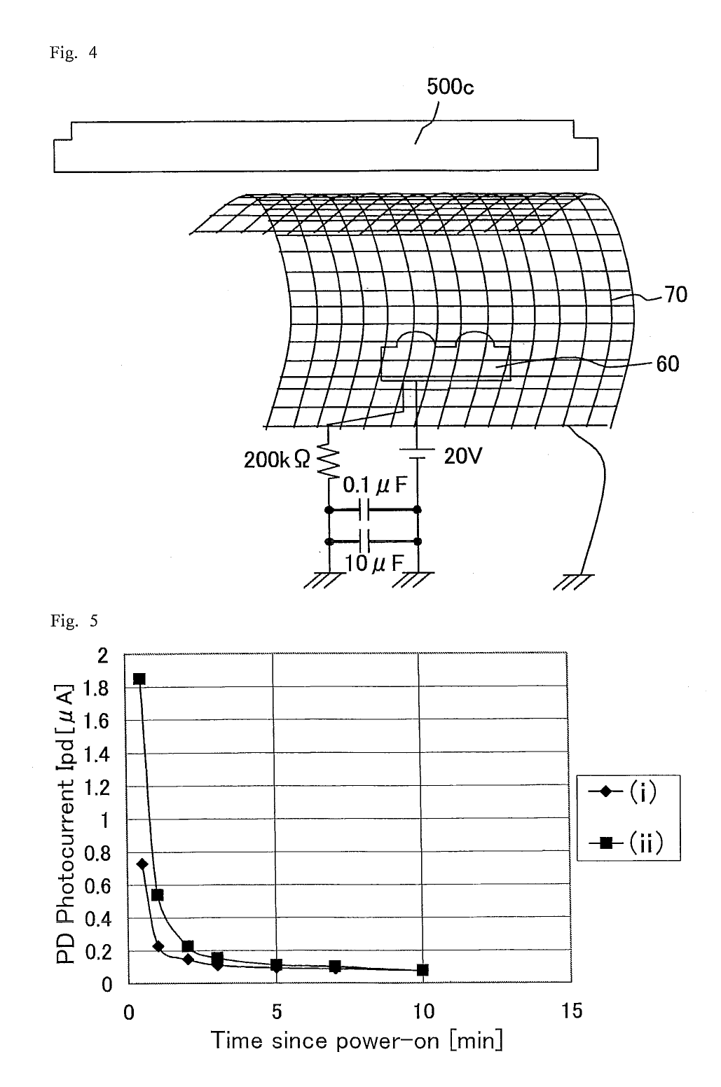

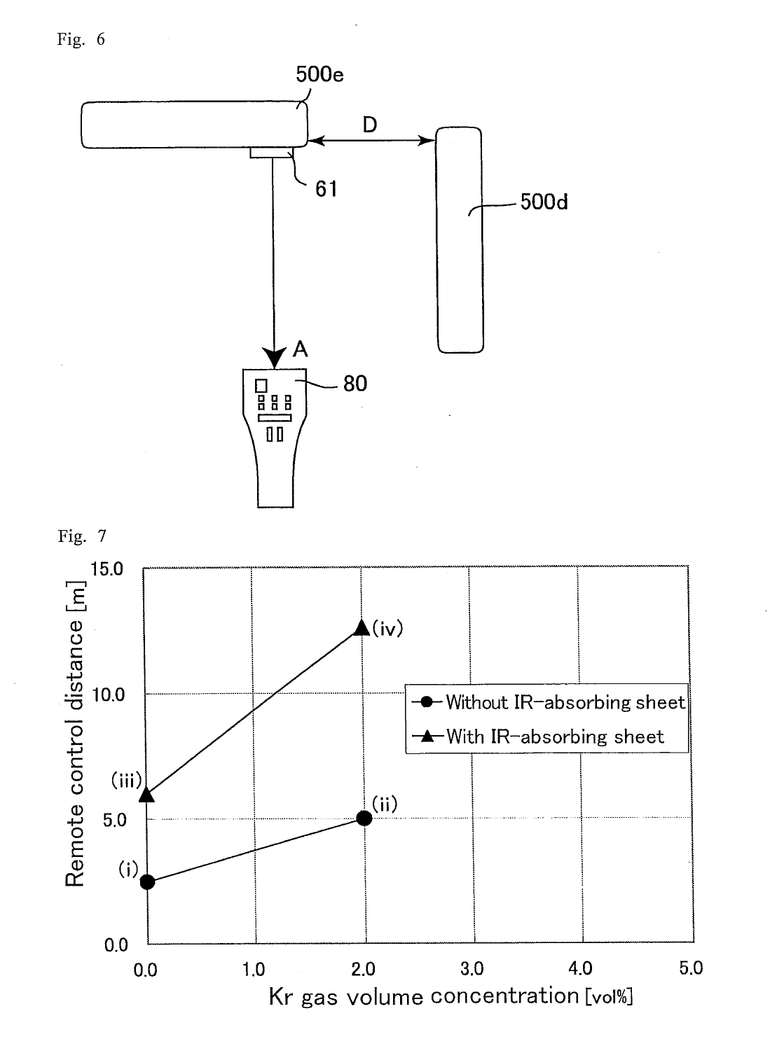

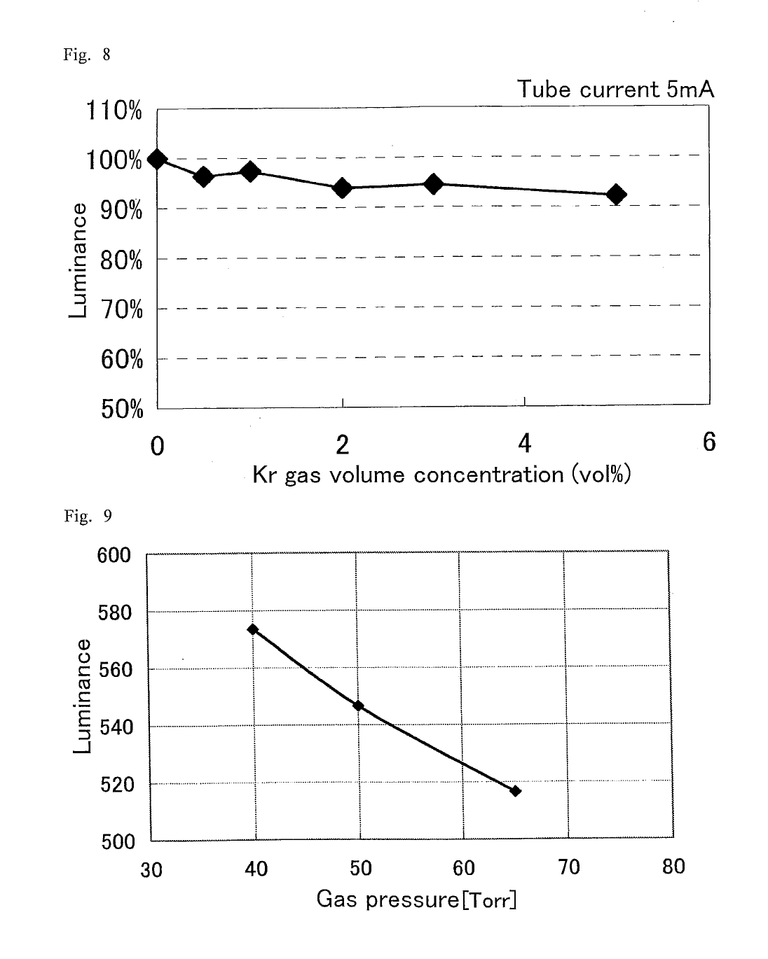

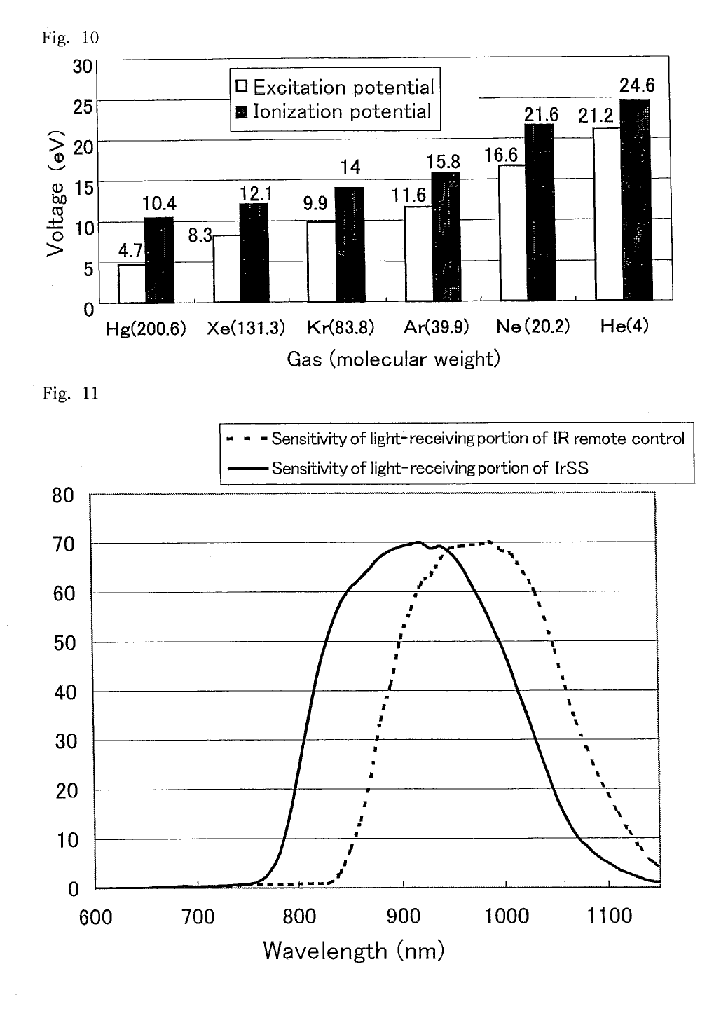

### EXPLANATION OF NUMERALS AND SYMBOLS

1a: First protective layer
1b: Second protective layer
1c: Third protective layer
1d: Fourth protective layer
2a: First polarizer
2b: Second polarizer
10: Backlight (BL) shield
11: Reflective sheet
12: Cold cathode fluorescent tube (CCFT)
13: Diffuser
14: Diffusion sheet
15: Prism sheet
16: Luminance-enhancing film
20a: Back substrate
20b: Front substrate
21a: Back polarizer
21b: Front polarizer
22a, 22b: Cohesive layer
23: Liquid crystal layer
24: Color filter
25: Coat layer
50: Infrared-absorbing sheet (shaded part)
50a: Protective layer containing infrared-absorbing dye (shaded part)
60, 61: Silicon photo diode (PD)
70: Shielding net
80: Infrared remote control
100: Lighting device for display devices
120: Glass envelope
121a: Cold cathode electrode
121b: Anode electrode
122: Fluorescent substance
200: Liquid crystal display panel
500c: LC TV receiver
500d: LC TV receiver (noise source)
500e: LC TV receiver (light receiver)

1. A discharge tube for infrared communication interference suppression, comprising a pair of electrodes,
wherein the discharge tube contains mercury, argon gas, and rare gas thereinside,
the rare gas having an excitation energy lower than that of argon gas.

2. The discharge tube according to claim 1,
wherein the rare gas is krypton gas.

3. The discharge tube according to claim 1,
wherein a volume concentration of the rare gas is 1 to 10 vol %.

4. The discharge tube according to claim 1,
wherein the discharge tube further contains neon gas thereinside.

5. The discharge tube according to claim 1,
wherein the discharge tube contains, on a wall face thereof, a fluorescent substance capable of converting ultraviolet emitted from the mercury excited by an electric discharge into visible light.

6. The discharge tube according to claim 5,
wherein the discharge tube is a cold cathode fluorescent tube, and
a gas pressure inside the tube is 6.7×10³ Pa or lower.

7. A lighting device for display devices, comprising the discharge tube of claim 5.

8. The lighting device according to claim 7,
comprising an infrared-absorbing sheet capable of absorbing infrared emitted from the discharge tube by emission of light produced by the rare gas.

9. The lighting device according to claim 8,
wherein the infrared-absorbing sheet does not substantially absorb visible light.

10. The lighting device according to claim 8,
wherein the infrared-absorbing sheet is arranged on an outermost light-exiting face side of the lighting device.

11. A LCD device comprising:
the lighting device of claim 7; and
a LCD panel.

12. The LCD device according to claim 11,
wherein the LCD panel includes a back polarizer, a liquid crystal layer, and a front polarizer in this order from the lighting device side, and
the LCD device includes the infrared-absorbing sheet between the lighting device and the back polarizer,
the infrared-absorbing sheet being capable of absorbing infrared emitted from the discharge tube by emission of light produced by the rare gas.

13. The LCD device according to claim 11,
wherein the LCD panel includes a back polarizer, a liquid crystal layer, and a front polarizer in this order from the lighting device, and
the LCD device includes the infrared-absorbing sheet on a front face-side of the front polarizer,
the infrared-absorbing sheet being capable of absorbing infrared emitted from the discharge tube by emission of light produced by the rare gas.

14. The LCD device of claim 11,
wherein the LCD panel includes a polarizer-protecting layer containing an infrared-absorbing dye.

15. The LCD device of claim 14,
wherein the polarizer-protecting layer is arranged on a lighting device-side surface of the LCD panel.
